(19) United States
(12) Patent Application Publication
(10) Pub. No.: US 2024/0282139 A1
(43) Pub. Date: Aug. 22, 2024

(54) METHOD, APPARATUS AND ELECTRONIC DEVICE FOR IMAGE PROCESSING

(71) Applicant: Beijing Zitiao Network Technology Co., Ltd., Beijing (CN)

(72) Inventors: Hui Hu, Beijing (CN); Zeming Li, Beijing (CN)

(21) Appl. No.: 18/583,414

(22) Filed: Feb. 21, 2024

(30) Foreign Application Priority Data
Feb. 21, 2023 (CN) 202310188600.4

(51) Int. Cl. G06V 40/10; G06T 7/73; G06V 10/44; G06V 10/80

(52) U.S. Cl. CPC G06V 40/11; G06T 7/73; G06V 10/44; G06V 10/806

(57) ABSTRACT

Embodiments of the disclosure discloses a method, apparatus, and electronic device for image processing. The method for image processing includes obtaining a plurality of hand images, the plurality of hand images being images of a target hand captured from a plurality of viewing angles; determining finger pose information based on the plurality of hand images; determining palm pose information based on the plurality of hand images; and determining pose information of the target hand based on the finger pose information and the palm pose information. The method for image processing can improve the accuracy of hand pose prediction.

### CROSS-REFERENCE

The present application claims priority to Chinese Patent Application No. 202310188600.4, filed on Feb. 21, 2023 and entitled “METHOD, APPARATUS AND ELECTRONIC DEVICE FOR IMAGE PROCESSING”, the entirety of which is incorporated herein by reference.

### FIELD

The present disclosure relates to the field of image processing, and more particularly to a method, apparatus and electronic device for image processing.

### BACKGROUND

Hand pose estimation is the most important part of pose recognition, and its stability and accuracy can impact the stability and accuracy of pose recognition. When performing hand pose estimation, a cut-out picture of a hand area can be input, and then a hand pose is predicted using a trained neural network model. The hand pose can be represented by a rotation amount of each joint of a hand, generally an axis angle or a rotation angle around a determined axis.

### SUMMARY

A content section of the disclosure is provided to briefly introduce the concepts, which will be described in detail in the following detailed description section. The content section of the disclosure is not intended to identify key features or necessary features of a claimed technical solution, nor is it intended to limit the scope of the claimed technical solution.

Embodiments of the present disclosure provides a method, apparatus and electronic device for image processing, which can improve the accuracy of hand pose prediction.

In a first aspect, embodiments of the present disclosure provide a method for image processing including: obtaining a plurality of hand images, the plurality of hand images being images of a target hand captured from a plurality of viewing angles; determining finger pose information based on the plurality of hand images; determining palm pose information based on the plurality of hand images; and determining pose information of the target hand based on the finger pose information and the palm pose information.

In a second aspect, embodiments of the present disclosure provide an apparatus for image processing including: an obtaining module configured for obtaining a plurality of hand images, the plurality of hand images being images of a target hand captured from a plurality of viewing angles; and a determination module configured for: determining finger pose information based on the plurality of hand images; determining palm pose information based on the plurality of hand images; and determining pose information of the target hand based on the finger pose information and the palm pose information.

In a third aspect, embodiments of the present disclosure provide an electronic device including: one or more processors; storage means for storing one or more programs that, when executed by the one or more processors, cause the one or more processors to implement the method for image processing according to the first aspect.

In a fourth aspect, embodiments of the present disclosure provide a computer-readable medium having a computer program stored thereon. The program, when executed by a processor, implements the method for image processing according to the first aspect.

### BRIEF DESCRIPTION OF THE DRAWINGS

The above and other features, advantages and aspects of the various embodiments of the present disclosure will become more apparent in conjunction with the accompanying drawings and with reference to the following detailed description. Throughout the drawings, same or similar reference numbers denote same or similar elements. It should be understood that the drawings are illustrative and that the components and elements are not necessarily drawn to scale.

FIG. 1 is an example diagram of an embodiment of a hand image according to the present disclosure;

FIG. 2 is a flowchart of an embodiment of a method for image processing according to the present disclosure;

FIGS. 3A to 3E are example diagrams of a pose prediction model according to the method for image processing of the present disclosure;

FIG. 4 is a schematic structural diagram of an embodiment of an apparatus for image processing according to the present disclosure;

FIG. 5 is an example system architecture in which a method for image processing according one embodiment of the present disclosure may be applied;

FIG. 6 is a schematic diagram of a basic structure of an electronic device provided according to embodiments of the present disclosure.

### DETAILED DESCRIPTION

Embodiments of the present disclosure will be described in the following in more detail with reference to the accompanying drawings. Although certain embodiments of the present disclosure are shown in the drawings, it should be understood that the present disclosure can be implemented in various forms and should not be construed as limited to the embodiments set forth herein. On the contrary, these embodiments are provided for a more thorough and complete understanding of the present disclosure. It should be understood that the accompanying drawings and embodiments of the present disclosure are for illustrative purposes only and are not intended to limit the scope of the present disclosure.

It should be understood that various steps described in a method implementation of the present disclosure can be executed in different orders and/or in parallel. In addition, the method implementation can include additional steps and/or omit the steps shown. The scope of the present disclosure is not limited in this regard.

The term “including” and its variations used herein are openly inclusive, i.e. “including but not limited to”. The term “based on” means “at least partially based on”. The term “one embodiment” means “at least one embodiment”; the term “another embodiment” means “at least one additional embodiment”; the term “some embodiments” means “at least some embodiments”. Relevant definitions of other terms will be given in the following description.

It should be noted that the concepts of “first” and “second” mentioned in this disclosure are only used to distinguish different apparatuses, modules, or units, and are not used to limit the order or interdependence of the functions performed by these apparatuses, modules, or units.

It should be noted that the modifications of “one” and “a plurality of” mentioned in this disclosure are illustrative and not restrictive. Those skilled in the art should understand that unless otherwise specified in the context, they should be understood as “one or more”.

The names of messages or information exchanged between a plurality of apparatuses in the present disclosure are for illustrative purposes only and are not intended to limit the scope of these messages or information.

A method, apparatus, and electronic device for image processing provided in the embodiments of the present disclosure predict hand pose based on images of a target hand captured from a plurality of viewing angles, wherein pose information of the target hand is determined after finger pose information and palm pose information are determined respectively. On one hand, the determination of the finger pose information is susceptible to other information. Thus, more information can be integrated based on images from a plurality of viewing angle, which eliminates interference from other information, and the determined finger pose information is more accurate. On the other hand, the finger pose information and palm pose information are determined separately and then are integrated to determine the pose information, which can not only ensure the accuracy of pose information, but also improve the prediction efficiency of the pose information. Therefore, the method, apparatus, and electronic device for image processing can improve the accuracy of hand pose estimation.

The scheme for image processing provided by the embodiments in the present disclosure can be applied to various application scenarios that require hand pose prediction. In some application scenarios, the prediction result of hand pose is a final result required. In other application scenarios, the prediction result of hand pose is used to further realize the prediction of hand posture. Therefore, the accuracy of hand pose prediction impacts the accuracy of hand posture prediction.

In related technologies, when hand pose estimation is performed, a cut out picture of a hand region is input, and then a trained neural networks model is used to predict the hand pose. The hand pose can be represented by an amount of rotation of each joint of a hand, generally be represented by an axis angle or a rotation angle around a determined axis.

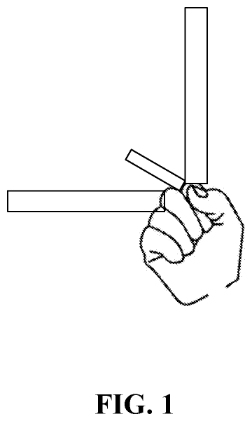

By using this hand pose prediction method, when encountering some complex backgrounds in which it is easy for some finger parts to be positioned on the background. As shown in FIG. 1, when a clenched hand is placed on a diagonal beam of a chair, the diagonal beam of the chair is easily confused with an index finger, resulting in the index finger pose predicted by the model being a straight pose rather than a clenched curved pose.

In addition, the hand pose prediction using only monocular images lacks scale information, and the estimated 3D position and pose is not accurate.

Based on this, the implementation of the present disclosure provides a scheme for image processing, which performs the hand pose prediction based on images of a target hand captured from a plurality of viewing angles which are used to determine finger pose information and palm pose information respectively. On one hand, the determination of finger pose information is more susceptible to other information, and thus, more information can be integrated based on the images from the plurality of viewing angles, which eliminates interference from other information, and the determined finger pose information is more accurate. On the other hand, the finger pose information and palm pose information are determined separately, and then integrated to determine the pose information, which can not only ensures the accuracy of the pose information, but also improve the prediction efficiency of the pose information.

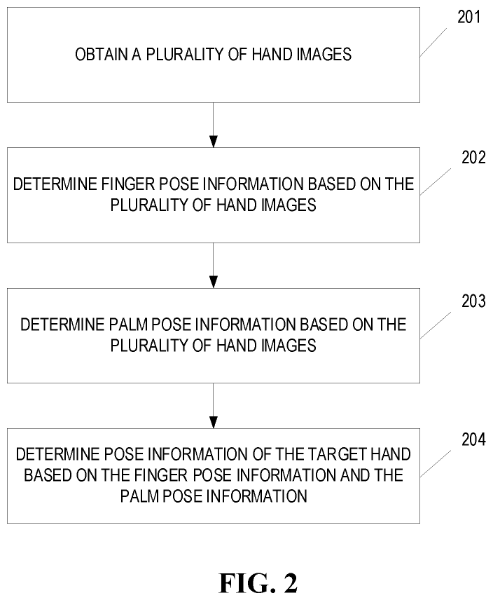

Please refer to FIG. 2, which shows a flowchart of an embodiment of a method for image processing according to the present disclosure. The method for image processing can be applied to a terminal device. As shown in FIG. 1, the image processing method includes the following steps.

At step 201, a plurality of hand images is obtained. Herein, the plurality of hand images are images of a target hand captured from a plurality of viewing angles.

In some embodiments, a viewing angle corresponds to a hand image. Therefore, the number of the plurality of hand images depends on the number of viewing angles at the time when the images are obtained.

In some embodiments, the plurality of viewing angles are configured in advance, and the images are captured based on the configured plurality of viewing angles, and the plurality of hand images can be obtained.

In some embodiments, the plurality of hand images may be captured by an image capture device based on the plurality of viewing angles. Capture may also be performed by a plurality of image capture devices corresponding to the plurality of viewing angles. In different application scenarios, the number of image capture devices and the capture method of the plurality of hand images may be configured according to the actual situation.

At step 202, finger pose information is determined based on the plurality of hand images.

In some embodiments, the image processing method further includes extracting pose features corresponding to the plurality of hand images respectively.

Therefore, the finger pose information may be determined based on the pose features corresponding to the plurality of hand images respectively.

Therefore, as an alternative implementation, step 202 includes determining a fused pose feature based on the pose features corresponding to the plurality of hand images respectively; and determining the finger pose information based on the fused pose features.

At step 203, palm pose information is determined based on the plurality of hand images.

In some embodiments, step 202 and step 203 may be performed simultaneously or may be performed in a corresponding order, which is not limited.

In some embodiments, alternatively, the palm pose information may be determined based on the pose features corresponding to the plurality of hand images respectively.

Therefore, as an alternative implementation, step 203 includes determining key points corresponding to the plurality of hand images respectively based on the pose features corresponding to the plurality of hand images respectively; and determining the palm pose information based on the key points corresponding to the plurality of hand images respectively.

In this implementation, the key points of the image are determined first, and then the palm pose information is determined using the key points.

In some embodiments, the key points corresponding to the plurality of hand images respectively are 2.5d key points, and the palm pose information is 3d pose information.

At Step 204, pose information of the target hand is determined based on the finger pose information and the palm pose information.

In some embodiments, after the finger pose information and palm pose information are determined respectively, the two kinds of information are integrated and the pose information of the target hand may be determined.

In embodiments of the present disclosure, at least one step of step 202-step 204 may be implemented by a pose prediction model.

Thus, as an alternative embodiment, step 202 includes determining the finger pose information based on the plurality of hand images and a predetermined pose prediction model.

In addition/alternatively, as an alternative embodiment, step 203 includes determining the palm pose information based on the plurality of hand images and the predetermined pose prediction model.

In addition/alternatively, as an alternative embodiment, step 204 includes determining the pose information of the target hand based on the finger pose information, the palm pose information and the predetermined pose prediction model.

In some embodiments, steps 202-204 are performed based on a predetermined pose prediction model, and the implementation of the predetermined pose prediction model will be described in the following.

In some embodiments, the predetermined pose prediction model includes a first prediction module and a second prediction module. The first prediction module is used to determine the finger pose information based on the plurality of hand images, and the second prediction module is used to determine the palm pose information based on the plurality of hand images. The pose information of the target hand is determined based on the finger pose information and the palm pose information.

In some embodiments, after the plurality of hand images are input into the predetermined pose prediction model, the finger pose information may be determined by the first prediction module, the palm pose information may be determined by the second prediction module and then the finger pose information and palm pose information are integrated to determine the pose information of the target hand finally.

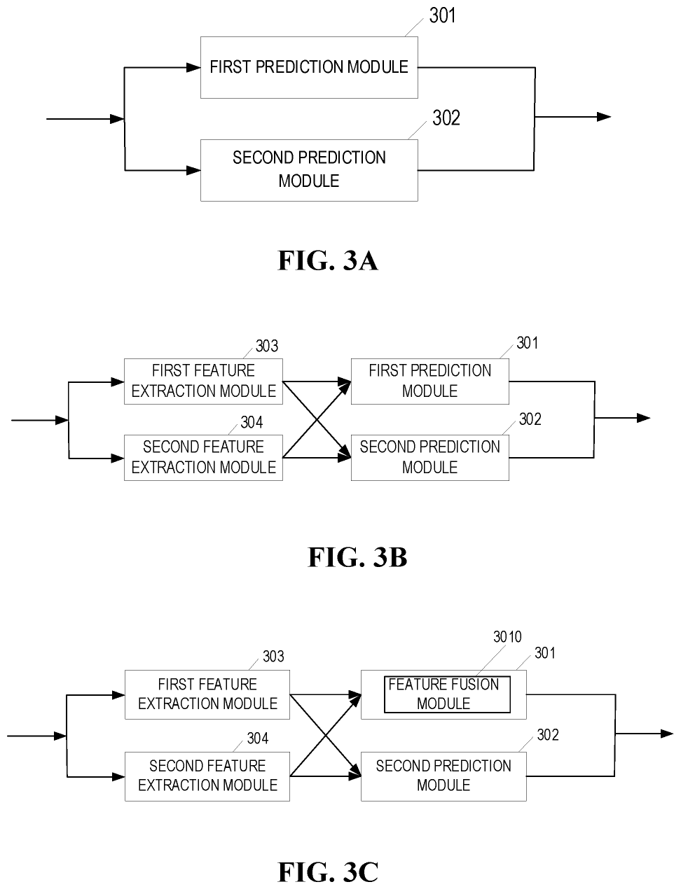

As an example, please refer to FIG. 3A, which is an example diagram of the predetermined pose prediction mode, the pose prediction model 30 includes a first prediction module 301 and a second prediction module 302. The plurality of hand images is input into the first prediction module 301 and the second prediction module 302. The first prediction module 301 outputs the finger pose information, and the second prediction module 302 outputs the finger pose information. After an integration of the two information, the pose prediction model 30 outputs the pose information of the target hand.

In some embodiments, the predetermined pose prediction model further includes a plurality of feature extraction modules, which are used for extracting pose features corresponding to the plurality of hand images respectively, wherein one feature extraction module is used for extracting the pose feature corresponding to one hand image. The finger pose information and the palm pose information are determined based on the pose feature corresponding to the plurality of hand images respectively.

In this implementation, the plurality of hand images needs to be extracted by the plurality of feature extraction modules first, and then further processed based on the extracted features.

In some embodiments, the plurality of feature extraction module is a module shared by the first prediction module and the second prediction module, i.e., the pose features output by the plurality of feature extraction modules may be used for the first prediction module and the second prediction module respectively.

In other embodiments, the plurality of feature extraction modules may be built in the first prediction module and the second prediction module respectively, i.e., the first prediction module and the second prediction module each include the plurality of feature extraction modules.

In some embodiments, a feature extraction module is used to extract the pose feature corresponding to one hand image, i.e., a feature extraction module is used to extract a pose feature from a viewing angle. Therefore, the number of feature extraction modules may be greater than or equal to the number of viewing angles corresponding to a plurality of hand images.

As an example, please refer to FIG. 3B, the pose prediction module 30 in FIG. 3B further includes: a first feature extraction module 303 and a second feature extraction module 304. A hand image from a first viewing angle is input into the first feature extraction module 303, and the first feature extraction module 303 outputs the pose feature from the first viewing angle. The hand image from the second viewing angle is input into the second feature extraction module 304, and the second feature extraction module 304 outputs the pose feature from the second viewing angle. Therefore, the pose feature from the first viewing angle and the pose feature from the second viewing angle are input into the first prediction module 301 and the second prediction module 302, so that the first prediction module 301 outputs finger pose information, and the second prediction module 302 outputs the palm pose information. The finger pose information and palm pose information are finally integrated into the pose information output of the target hand.

In some embodiments, the first prediction module includes a feature fusion module. The feature fusion module determines a fusion pose feature based on the pose features corresponding to the plurality of hand images respectively, and determines the finger pose information based on the fusion pose feature.

It can be understood that the pose features corresponding to the plurality of hand images may not be consistent, so the fusion pose features with consistency can be determined first, and then the finger pose information can be determined based on the fusion pose features.

In other embodiments, the feature fusion module may first determine a plurality of finger pose information based on the pose features corresponding to the plurality of hand images respectively, and then performs the fusion based on the plurality of finger pose information to determine the finger pose information with consistency

As an example, please referring to FIG. 3C, the first prediction module 301 includes a feature fusion module 3010 in FIG. 3C. The pose features of the first and second viewing angles are input to the feature fusion module 3010, and the feature fusion module 3010 outputs the fused finger pose information with consistency.

Therefore, based on images from the plurality of view angles, information from more viewing angles may be obtained to achieve more accurate prediction of finger pose with the first prediction module.

In some embodiments, the second prediction module is used for outputting 3D pose information of the palm, so that the second prediction module may perform the prediction of the palm pose information based on a multi-view geometry method.

The multi-view geometry method may solve 3D poses through 2.5d poses. At a model level, there is no need to learn internal and external parameters of image capture devices (such as cameras), so it does not require the multi-view cameras to use a fixed placement position, which is more flexible and accurate.

In some embodiments, the second prediction module includes a key point locating module, which is used for determining the key points corresponding to the plurality of hand images respectively based on the pose features corresponding to the plurality of hand images respectively.

In some embodiments, the second prediction module further includes a palm pose solving module, which is used for determining the palm pose information based on the key points corresponding to the plurality of hand images respectively.

In this implementation, the second prediction module first determines the respective key points based on the pose features corresponding to the plurality of hand images respectively, and then uses the respective key points to solve the palm pose information.

In some embodiments, the key points corresponding to the plurality of hand images respectively are 2.5d key points, and the palm pose information is 3d pose information. Therefore, for the palm pose solving module, the solution of the 3D pose is realized through the 2.5d key points.

As an example, please referring to FIG. 3D, the second prediction module 302 in FIG. 3D includes a key point locating module 3020 and a palm pose solving module 3021. The pose features of the first viewing angle and the second viewing angle are input to the key point locating module 3020, and the key point locating module 3020 outputs the located key points. The located key points are input to the palm pose solving module 3021 for solution and output the palm pose information.

In some embodiments, the predetermined pose prediction module further includes a pose information integration module, which is used for determining the pose information of the target hand based on the finger pose information and palm pose information.

In this embodiment, the pose information integration module may realize the integration of finger pose information and 3D palm pose information, and output the pose information of the target hand.

In some embodiments, assume that the finger pose information is of 20dof (degrees of freedom, dimension) and the palm pose information is of 6dof, the final pose information is of 26dof, which is consistent with the current hand pose information but with a higher accuracy.

As an example, please refer to FIG. 3E, the pose prediction model 30 in FIG. 3E further includes a pose information integration module 305. The finger pose information output by the first prediction module 30, and the palm pose information output by the second prediction module 302 are all input to the pose information integration module 305. The pose information integration module 305 performs information integration and outputs the pose information of the target hand, which is also the final output result of the pose prediction model 30.

In some embodiments, based on the model structure of the pose prediction model, the pose prediction model may be trained in advance, so that the trained pose prediction model may directly achieve hand pose prediction based on the hand images from the plurality of view angles.

Thus, as an alternative embodiment, the method for image processing further includes obtaining a training dataset comprising a plurality of sample hand images, each sample hand image having corresponding finger pose information and palm pose information; and determining the predetermined pose prediction model based on the plurality of sample hand images and an initial pose prediction model.

In some embodiments, determining the predetermined pose prediction model based on the plurality of sample hand images and an initial pose prediction model includes training the first prediction module based on the finger pose information corresponding to the plurality of sample hand images, and training the second prediction module based on the palm pose information corresponding to the plurality of sample hand images, to obtain the predetermined pose prediction model.

In this embodiment, the training dataset is configured in advance, which include the plurality of sample hand images, with set labels being the finger pose information and the palm pose information.

Based on the finger pose information therein, the first prediction module may be trained, and based on the palm pose information, the second prediction module may be trained to complete the training of the entire pose prediction model.

In other embodiments, in combination with different model structures, additional labels may be configured, or more flexible methods for model training may be used. For example, for the aforementioned feature extraction module, extracted feature labels may also be configured.

In some embodiments, when a training dataset is predetermined, a portion of the data may also be used as a test dataset, which is used for an accuracy test for the predetermined pose prediction model to optimize the model based on the test results.

In some embodiments, in addition to the aforementioned test dataset, some implementations may also be taken to improve the accuracy of the model, which are, for example, predetermining a number of training for a plurality of trainings and considering that the training of the model is completed after reaching the predetermined number of training.

Thus, after the training of the model is completed, the trained pose prediction model is the predetermined pose prediction model, which may obtain a higher accuracy of hand pose prediction result based on hand images from the plurality of view angles.

Based on the more accurate hand pose prediction results, applications such as more accurate hand posture prediction may further be realized.

Therefore, through the introduction of the implementation of the present disclosure, on one hand, the determination of the finger pose information is susceptible to other information. Thus, more information can be integrated based on images from a plurality of viewing angle, which eliminates interference from other information, and the determined finger pose information is more accurate. On the other hand, the finger pose information and palm pose information are determined separately and then are integrated to determine the pose information, which can not only ensure the accuracy of pose information, but also improve the prediction efficiency of the pose information. Therefore, the scheme for image processing can improve the accuracy of hand pose estimation.

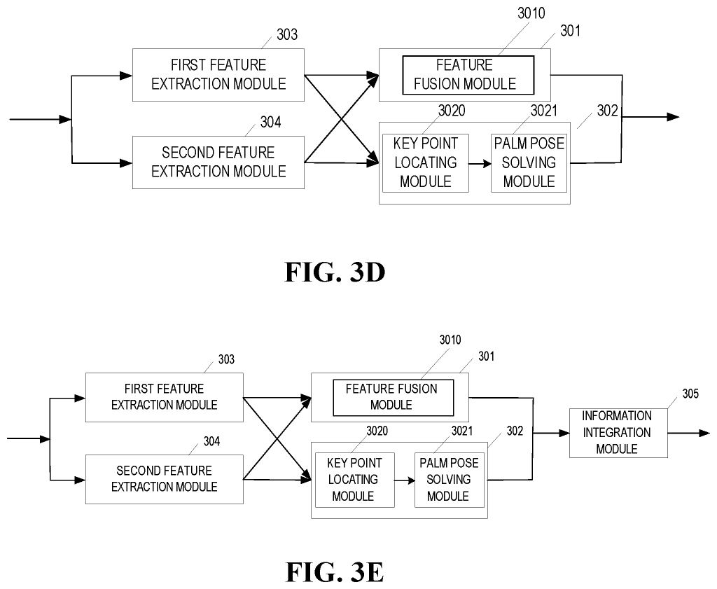

With further reference to FIG. 4, as an implementation of the methods shown in the above figures, the present disclosure provides an embodiment of an apparatus for image processing, which corresponds to the method for image processing shown in FIG. 1. The apparatus may be specifically applied to various electronic devices.

As shown in FIG. 4, the apparatus for image processing includes: an obtaining module 401 configured for obtaining a plurality of hand images, the plurality of hand images being images of a target hand captured from a plurality of viewing angles; and a determination module 402 configured for determining finger pose information based on the plurality of hand images; determining palm pose information based on the plurality of hand images; and determining pose information of the target hand based on the finger pose information and the palm pose information.

In some embodiments, the determination module 402 is further configured for extracting pose features corresponding to the plurality of hand images respectively; the finger pose information and/or the palm pose information being determined based on the pose features corresponding to the plurality of hand images respectively.

In some embodiments, the determination module 402 is further configured for determining a fused pose feature based on the pose features corresponding to the plurality of hand images respectively; and determining the finger pose information based on the fused pose features.

In some embodiments, the determination module 402 is further configured for determining key points corresponding to the plurality of hand images respectively based on the pose features corresponding to the plurality of hand images respectively; and determining the palm pose information based on the key points corresponding to the plurality of hand images respectively.

In some embodiments, the key points corresponding to the plurality of hand images respectively are 2.5d key points, and the palm pose information is 3d pose information.

In some embodiments, the determination module 402 is further configured for determining the finger pose information based on the plurality of hand images and a predetermined pose prediction model.

In some embodiments, the determination module 402 is further configured for determining the palm pose information based on the plurality of hand images and the predetermined pose prediction model.

In some embodiments, the determination module 402 is further configured for determining the pose information of the target hand based on the finger pose information, the palm pose information and the predetermined pose prediction model.

In some embodiments, the apparatus for image processing further includes a training module 403 configured for obtaining a training dataset comprising a plurality of sample hand images, each sample hand image having corresponding finger pose information and palm pose information; and determining the predetermined pose prediction model based on the plurality of sample hand images and an initial pose prediction model.

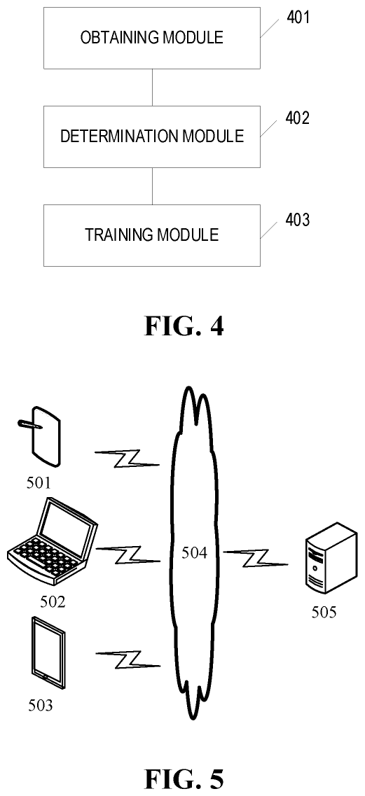

Please refer to FIG. 5, FIG. 5 shows an example system architecture in which a method for image processing according one embodiment of the present disclosure may be applied.

As shown in FIG. 5, the system architecture may include terminal devices 501, 502, 503, a network 504, a server 505. The network 504 may be used as a medium to provide a communication link between the terminal devices 501, 502, 503 and the server 505. The network 504 may include various connection types, such as wired, wireless communication links or fiber optic cables, etc.

The terminal devices 501, 502, 503 can interact with the server 505 through the network 504 to receive or send messages, etc. Various client applications can be installed on the terminal devices 501, 502, 503, such as, webpage browsing applications, search applications, and news and information applications. The client applications in the terminal devices 501, 502, 503 can receive user instructions and complete corresponding functions according to user instructions, such as adding corresponding information to information according to user instructions.

The terminal devices 501, 502, and 503 can be hardware or software. When terminal devices 501, 502, and 503 are hardware, they can be various electronic devices with display screens and support for webpage browsing, including but not limited to smartphones, tablets, e-book readers, MP3 players (Moving Picture Experts Group Audio Layer III, Moving Picture Experts Compression Standard Audio Layer 3), MP4 players (Moving Picture Experts Group Audio Layer IV, Moving Picture Experts Compression Standard Audio Layer 4), laptop computers, and desktop computers, etc. When the terminal devices 501, 502, and 503 are software, they can be installed in the electronic devices listed above. They can be implemented as a plurality of software or software modules (such as software or software modules used to provide distributed services), or as a single software or software module. No specific limitations are made here.

Server 505 may be a server that provides various services, such as receiving information obtaining requests sent by the terminal devices 501, 502, 503, obtaining display information corresponding to the information obtaining request through various means according to the information obtaining request, and sending relevant data of the display information to the terminal devices 501, 502, 503.

It should be noted that the method for image processing provided by the embodiments of the present disclosure can be executed by a terminal device, and correspondingly, the apparatus for image processing can be set in the terminal devices 501, 502, 503. In addition, the method for image processing provided by the embodiments of the present disclosure can also be executed by the server 505, and correspondingly, the image processing device can be set in the server 505.

It should be understood that the number of terminal devices, networks, and servers in FIG. 5 is merely illustrative and there may be any number of terminal devices, networks, and servers as required by the implementation.

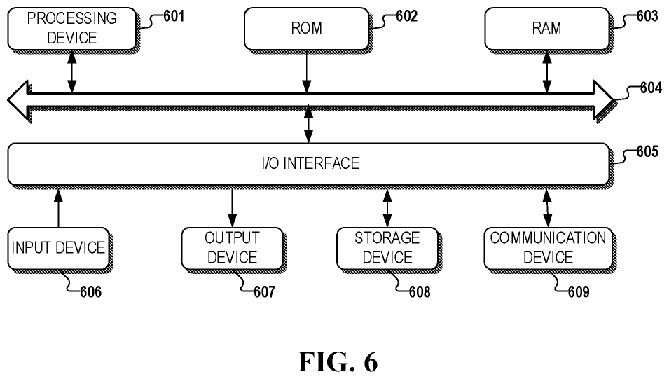

Referring now to FIG. 6, there is shown a schematic structural diagram of an electronic device (e. g., a terminal device or a server in FIG. 5) suitable for implementing embodiments of the present disclosure. Terminal devices in embodiments of the present disclosure may include, but are not limited to, mobile terminals such as mobile phones, notebook computers, digital broadcast receivers, PDAs (personal digital assistants), PADs (tablet computers), PMPs (portable multimedia players), car terminals (e. g., car navigation terminals) and the like, as well as fixed terminals such as digital TVs, desktop computers and the like.

As shown in FIG. 6, the electronic device may include a processing device (such as a Central Processor, Graphics Processor, etc.) 601, which can perform various appropriate actions and processes based on programs stored in a read-only memory (ROM) 602 or loaded from a storage device 608 into a random-access memory (RAM) 603. In RAM 603, various programs and data required for the operation of the electronic device 600 are also stored. The processing device 601, ROM 602, and RAM 603 are connected to each other through a bus 604. The input/output (I/O) interface 605 is also connected to the bus 604.

Typically, the following devices can be connected to I/O interface 605: input devices 606 including, for example, touch screens, touchpads, keyboards, mice, cameras, microphones, accelerometers, gyroscopes, etc.; output devices 607 including, for example, liquid crystal displays (LCDs), speakers, vibrators, etc.; storage devices 608 including, for example, magnetic tapes, hard disks, etc.; and communication devices 609. Communication devices 609 can allow electronic devices to communicate wirelessly or wirelessly with other devices to exchange data. Although FIG. 6 shows electronic devices with various devices, it should be understood that it is not required to implement or have all the devices shown. More or fewer devices can alternatively be implemented or have them.

In particular, according to embodiments of the present disclosure, the process described above with reference to the flowchart may be implemented as a computer software program. For example, embodiments of the present disclosure include a computer program product comprising a computer program carried on a non-transitory computer-readable medium, the computer program comprising program code for performing the method shown in the flowchart. In such embodiments, the computer program may be downloaded and installed from the network through the communication device 609, or from the storage device 608, or from the ROM 602. When the computer program is executed by the processing device 601, the above-described functions defined in the methods of the embodiments of the present disclosure are performed.

It should be noted that the computer-readable medium described above can be a computer-readable signal medium, a computer-readable storage medium, or any combination thereof. The computer-readable storage medium can be, for example, but not limited to, an electrical, magnetic, optical, electromagnetic, infrared, or semiconductor system, device, or any combination thereof. More specific examples of computer-readable storage media can include but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium can be any tangible medium containing or storing a program that can be used by an instruction execution system, device, or device, or in combination therewith. In the present disclosure, a computer-readable signal medium can be included in a baseband or as part of a carrier wave propagation data signal, which carries computer-readable program code. The propagated data signal can take various forms, including but not limited to electromagnetic signals, optical signals, or any suitable combination thereof. The computer-readable signal medium can also be any computer-readable medium other than a computer-readable storage medium, which can send, propagate, or transmit programs for use by or in combination with instruction execution systems, devices, or devices. The program code contained on the computer-readable medium can be transmitted using any suitable medium, including but not limited to: wires, optical cables, RF (radio frequency), etc., or any suitable combination thereof.

In some implementation methods, clients and servers can communicate using any currently known or future developed network protocol such as HTTP (HyperText Transfer Protocol) and can interconnect with any form or medium of digital data communication (such as communication networks). Examples of communication networks include local area networks (“LANs”), wide area networks (“WANs”), the Internet (such as the Internet), and end-to-end networks (such as ad hoc end-to-end networks), as well as any currently known or future developed networks.

The above-described computer-readable medium may be contained in the above-described electronic device; or it may exist alone and not be assembled into the electronic device.

The above-described computer-readable medium carries one or more programs, when executed by the electronic device, cause the electronic device to: obtain a plurality of hand images, the plurality of hand images being images of a target hand captured from a plurality of viewing angles; determine finger pose information based on the plurality of hand images; determine palm pose information based on the plurality of hand images; and determine pose information of the target hand based on the finger pose information and the palm pose information.

Computer program code for performing the operations of the present disclosure may be written in one or more programming languages, or combinations thereof, including but not limited to Object Oriented programming languages such as Java, Smalltalk, C++, and also including conventional procedural programming languages such as “C” or similar programming languages. The program code may be executed entirely on the user's computer, partially on the user's computer, as a standalone software package, partially on the user's computer, partially on a remote computer, or entirely on a remote computer or server. In the case of a remote computer, the remote computer may be connected to the user's computer through any type of network, including a local area network (LAN) or a wide area network (WAN), or may be connected to an external computer (e.g., using an Internet service provider to connect over the Internet).

The flowcharts and block diagrams in the accompanying drawings illustrate the architecture, functions, and operations of the systems, methods, and computer program products that may be implemented in accordance with various embodiments of the present disclosure. In this regard, each block in the flowcharts or block diagrams may represent a module, program segment, or portion of code that contains one or more executable instructions for implementing the specified logical functions. It should also be noted that in some alternative implementations, the functions marked in the blocks may also occur in a different order than those marked in the figures. For example, two consecutive blocks may actually be executed in substantially parallel, and they may sometimes be executed in the opposite order, depending on the functions involved. It should also be noted that each block in the block diagrams and/or flowcharts, as well as combinations of blocks in the block diagrams and/or flowcharts, may be implemented using a dedicated hardware-based system that performs the specified functions or operations, or may be implemented using a combination of dedicated hardware and computer instructions.

The units described in the embodiments of the present disclosure can be implemented by software or hardware. The name of the unit does not limit the unit itself in some cases. For example, obtaining module 401 can also be described as “obtaining a plurality of hand images”.

The functions described above in this article can be at least partially performed by one or more hardware logic components. For example, without limitation, example types of hardware logic components that can be used include field programmable gate arrays (FPGAs), application specific integrated circuits (ASICs), application specific standard products (ASSPs), system-on-chip (SOCs), complex programmable logic devices (CPLDs), and so on.

In the context of this disclosure, a machine-readable medium can be a tangible medium that can contain or store programs for use by or in conjunction with an instruction execution system, device, or device. A machine-readable medium can be a machine-readable signal medium or a machine-readable storage medium. Machine-readable media can include, but are not limited to, electronic, magnetic, optical, electromagnetic, infrared, or semiconductor systems, devices, or devices, or any suitable combination thereof. More specific examples of machine-readable storage media may include electrical connections based on one or more wires, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination thereof.

The above description is only the preferred embodiment of the present disclosure and the explanation of the technical principles used. Those skilled in the art should understand that the scope of the disclosure involved in the present disclosure is not limited to the technical solutions formed by specific combinations of the above technical features, but should also cover other technical solutions formed by any combination of the above technical features or their equivalent features without departing from the above disclosure concept. For example, the technical solutions formed by replacing the above features with (but not limited to) technical features with similar functions disclosed in the present disclosure.

In addition, although the operations are depicted in a specific order, this should not be understood as requiring these operations to be performed in the specific order shown or in sequential order. In certain environments, multitasking and parallel processing may be advantageous. Similarly, although several specific implementation details are included in the above discussion, these should not be construed as limiting the scope of the present disclosure. Certain features described in the context of individual embodiments can also be implemented in combination in a single embodiment. Conversely, various features described in the context of a single embodiment can also be implemented separately or in any suitable sub-combination in a plurality of embodiments.

Although the subject matter has been described in language specific to structural features and/or methodological logical acts, it should be understood that the subject matter defined in the appended claims is not necessarily limited to the particular features or acts described above. Rather, the particular features and acts described above are merely example forms of implementation of the claims.

1. A method of image processing, comprising:
obtaining a plurality of hand images, the plurality of hand images being images of a target hand captured from a plurality of viewing angles;
determining finger pose information based on the plurality of hand images;
determining palm pose information based on the plurality of hand images; and
determining pose information of the target hand based on the finger pose information and the palm pose information.

2. The method of image processing of claim 1, wherein the method of image processing further comprises:
extracting pose features corresponding to the plurality of hand images respectively;
the finger pose information and/or the palm pose information being determined based on the pose features corresponding to the plurality of hand images respectively.

3. The method of image processing of claim 2, wherein the determining finger pose information based on the plurality of hand images comprises:
determining a fused pose feature based on the pose features corresponding to the plurality of hand images respectively; and
determining the finger pose information based on the fused pose features.

4. The method of image processing of claim 2, wherein the determining palm pose information based on the plurality of hand images comprises:
determining key points corresponding to the plurality of hand images respectively based on the pose features corresponding to the plurality of hand images respectively; and
determining the palm pose information based on the key points corresponding to the plurality of hand images respectively.

5. The method of image processing of claim 4, wherein the key points corresponding to the plurality of hand images respectively are 2.5d key points, and the palm pose information is 3d pose information.

6. The method of image processing of claim 1, wherein the determining finger pose information based on the plurality of hand images comprises:
determining the finger pose information based on the plurality of hand images and a predetermined pose prediction model.

7. The method of image processing of claim 6, wherein the determining palm pose information based on the plurality of hand images comprises:
determining the palm pose information based on the plurality of hand images and the predetermined pose prediction model.

8. The method of image processing of claim 6, wherein the determining pose information of the target hand based on the finger pose information and the palm pose information comprises:
determining the pose information of the target hand based on the finger pose information, the palm pose information and the predetermined pose prediction model.

9. The method of image processing of claim 8, wherein the method of image processing further comprises:
obtaining a training dataset comprising a plurality of sample hand images, each sample hand image having corresponding finger pose information and palm pose information; and
determining the predetermined pose prediction model based on the plurality of sample hand images and an initial pose prediction model.

10. An electronic device, comprising:
one or more processors;
storage means for storing one or more programs that, when executed by the one or more processors, cause the one or more processors to implement acts comprising:
obtaining a plurality of hand images, the plurality of hand images being images of a target hand captured from a plurality of viewing angles;
determining finger pose information based on the plurality of hand images;
determining palm pose information based on the plurality of hand images; and
determining pose information of the target hand based on the finger pose information and the palm pose information.

11. The electronic device of claim 10, wherein the acts further comprise:
extracting pose features corresponding to the plurality of hand images respectively;
the finger pose information and/or the palm pose information being determined based on the pose features corresponding to the plurality of hand images respectively.

12. The electronic device of claim 11, wherein the determining finger pose information based on the plurality of hand images comprises:
determining a fused pose feature based on the pose features corresponding to the plurality of hand images respectively; and
determining the finger pose information based on the fused pose features.

13. The electronic device of claim 11, wherein the determining palm pose information based on the plurality of hand images comprises:
determining key points corresponding to the plurality of hand images respectively based on the pose features corresponding to the plurality of hand images respectively; and
determining the palm pose information based on the key points corresponding to the plurality of hand images respectively.

14. The electronic device of claim 13, wherein the key points corresponding to the plurality of hand images respectively are 2.5d key points, and the palm pose information is 3d pose information.

15. The electronic device of claim 10, wherein the determining finger pose information based on the plurality of hand images comprises:
determining the finger pose information based on the plurality of hand images and a predetermined pose prediction model.

16. The electronic device of claim 15, wherein the determining palm pose information based on the plurality of hand images comprises:
determining the palm pose information based on the plurality of hand images and the predetermined pose prediction model.

17. The electronic device of claim 15, wherein the determining pose information of the target hand based on the finger pose information and the palm pose information comprises:
determining the pose information of the target hand based on the finger pose information, the palm pose information and the predetermined pose prediction model.

18. The electronic device of claim 17, wherein the acts further comprise:
obtaining a training dataset comprising a plurality of sample hand images, each sample hand image having corresponding finger pose information and palm pose information; and
determining the predetermined pose prediction model based on the plurality of sample hand images and an initial pose prediction model.

19. A non-transitory computer-readable medium having a computer program stored thereon, wherein the computer program, when executed by a processor, implements acts comprising:
obtaining a plurality of hand images, the plurality of hand images being images of a target hand captured from a plurality of viewing angles;
determining finger pose information based on the plurality of hand images;
determining palm pose information based on the plurality of hand images; and
determining pose information of the target hand based on the finger pose information and the palm pose information.

20. The non-transitory computer-readable medium of claim 19, wherein the acts further comprise:
extracting pose features corresponding to the plurality of hand images respectively;
the finger pose information and/or the palm pose information being determined based on the pose features corresponding to the plurality of hand images respectively.
